(19) United States
(12) Patent Application Publication
(10) Pub. No.: US 2002/0009990 A1
(43) Pub. Date: Jan. 24, 2002

(54) WAP-group-call

(75) Inventors: Stephan Kleier, Dusselforf (DE); Frank Timphus, Dusseldorf (DE); Christian Wietfeld, Falkensee (DE); Christian Herzog, Berlin (DE)

Correspondence Address: COHEN, PONTANI, LIEBERMAN & PAVANE, Suite 1210, 551 Fifth Avenue, New York, NY, 10176, US

(73) Assignee: Mannesmann AG Siemens AG

(21) Appl. No.: 09/885,213

(22) Filed: Jun. 20, 2001

(30) Foreign Application Priority Data
Jun. 20, 2000 (DE) 100 30 189.4

(51) Int. Cl. H04M 3/42

(52) U.S. Cl. 455/416; 455/414; 455/566

(57) ABSTRACT

A method for setting up a telephone conference between more than two subscribers of a telecommunication network in a simple ergonomic way in that, when a telephone conference is requested by a subscriber of a telecommunication network, subscribers stored in a list are connected together via a bridge to form a telephone conference together with the subscriber requesting the telephone conference.

### BACKGROUND OF THE INVENTION

The invention relates to methods and devices for setting up a telephone conference between more than two telecommunication subscribers.

The sequential setting-up of telephone connections to the participants in a telephone conference is known from the publications GSM Multiparty (MPTY) Supplementary Service (ITSI): GSM 02.84 (Stage 1), GSM Voice Group Call Service (ETSI): GSM 02.68 (Stage 1, GSM 03.68 (Stage 2)), ISDN telephone conference (ITUT): I 254.1 (Conference Calling), I 254.2 (Three-Party Supplementary Service), MIT-ME Conference (MMC) Supplementary Service (ETSI Standard ETS 300165). In these arrangements, the individual participants in the telephone conference are called individually and connected additionally to the telephone conference circuit.

### SUMMARY OF THE INVENTION

The object of the present invention is to provide an ergonomic method and, respectively, a device for setting up a telephone conference between more than two participants which, at the same time, can be implemented in the simplest and most efficient possible manner.

The prior definition and storing of a group of participants in a list allows an ergonomic and efficient way of setting up connections for a telephone conference since the connection to the participants of a list can be set up in parallel. In particular, the connection set-up for the telephone conference can be implemented in accordance with the following two embodiments of the invention.

According to one embodiment of the invention, the connection set-up can be initiated by the participant initiating the telephone conference in that he calls a telephone number (stored, for example, in the phone book of his mobile terminal or his mobile subscriber identity card) and the connections to the participants in the telephone conference are set up in that an element (server) at the telecommunication network end sets up connections to these participants stored in a list (unconditionally or after accepting an invitation). This telephone number can be a (virtual) telephone number not associated with any particular participant, which, when it is called, triggers the setting-up of a mobile radio telephone conference connection by elements (servers) at the telecommunication network end.

According to an alternative embodiment of the invention, a telephone conference connection for a group of participants (for example after a telephone number triggering the connection set-up has been called) is set up in such a manner that an element (server) at the telecommunication network end transmits a message (for example SMS PtP short message or WAP Deck/WAP Card) to the participants in the list for this group, a telecommunication connection to a participant being set up by him dialing a conference telephone number (bridge) (previously transmitted to him in a message).

Before or during the setting-up of the connection, an enquiry is preferably placed with participants whether the invitation to the conference connection is accepted. A conference circuit to a participant will then only be set up in each case if the participant has accepted the invitation, for example by sending back a DTMF signal.

The names and/or telephone numbers of each participant of a group in a list of conference participants are suitably stored in the mobile radio terminal or a mobile radio subscriber identity card, for example in the phone book of the subscriber or, as an alternative, by the telecommunication network individually for the participant.

The method is particularly suitable for setting up telephone conference circuits via at least one mobile radio network (for example GSM, UMTS etc.).

Preferably, only participants in a conference telecommunication connection which are contained in a group are connected additionally. This prevents other subscribers (who are not contained in a list according to which a conference has been or is currently being set up), who are accidentally calling a member of the group, from unintentionally being included in a telephone conference circuit.

A telephone conference circuit according to the invention is, in particular, a voice telecommunication connection (voice conference circuit) but can also be a data conference circuit in which the conference takes place by alphanumeric data transmission instead of by voice.

At the network end, the telephone conference can be implemented on an IN basis. It is possible to implement GSM conference call features.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 shows a menu implemented under WAP for a screen display for a mobile radio terminal which refers to a conference circuit according to the invention;

FIG. 2 shows a submenu for the screen menu according to FIG. 1 shown at the terminal end;

FIG. 3 shows a submenu for FIG. 2;

FIGS. 4/5 show other submenus for entering participants in a group into a list and storing it;

FIG. 6 shows a menu for a variant according to the invention of a connection set-up initiated by a network;

FIG. 7 shows an example of the representation of a participant invited to the telephone conference on the screen of a mobile radio terminal;

FIG. 8 diagrammatically shows a connection set-up to the participants in a telephone conference list, initiated at the network end;

FIG. 9 shows an invitation to an alternative set-up of a telephone conference according to the invention in the form of a telephone conference telephone number being dialed by all invited subscribers; and

FIG. 10 shows a rough block diagram of the setting-up of a telephone conference according to FIG. 9.

### DETAILED DESCRIPTION OF THE PREFERRED EMBODIMENTS

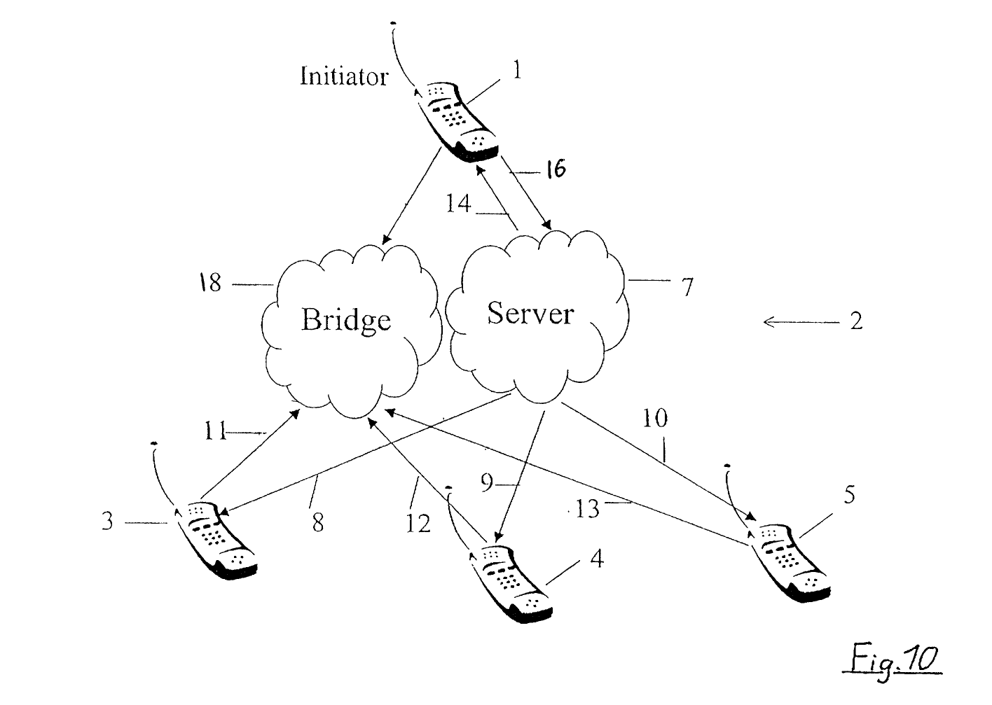

In the text which follows, the setting-up of a list according to the invention of participants in a group for a telephone conference between the members of this group are explained with reference to FIGS. 1-7, 9, and then two exemplary embodiments according to the invention for the connection/set-up are explained with reference to the block diagrams of FIG. 8 and FIG. 10.

FIG. 1 shows a menu which can be displayed on the screen of a mobile terminal(MS) of a mobile radio subscriber. In the present case, the menu is implemented under WAP (wireless application protocol). The submenu shown in FIG. 1 relates to the dialing up of an existing group of members for a telephone conference between the members of this group (No. 1-3) and the definition of a new group of participants by entering names and/or telephone numbers of the participants in a list to be stored in the terminal or on a card or at the network end.

In the menu in FIG. 1, for example, a telephone conference can be initiated to the members of group 1 (friends) by pressing key 1 on the mobile terminal on which this menu is displayed (or acoustically). This correspondingly applies to numbers 2 and 3 of the menu designated as “beer” or “basketball”. The name for a menu can be selected arbitrarily by the user of the mobile terminal. If item 4 in FIG. 1 is selected (for example by pressing key 4 on the mobile terminal), the menu according to FIG. 2 is displayed.

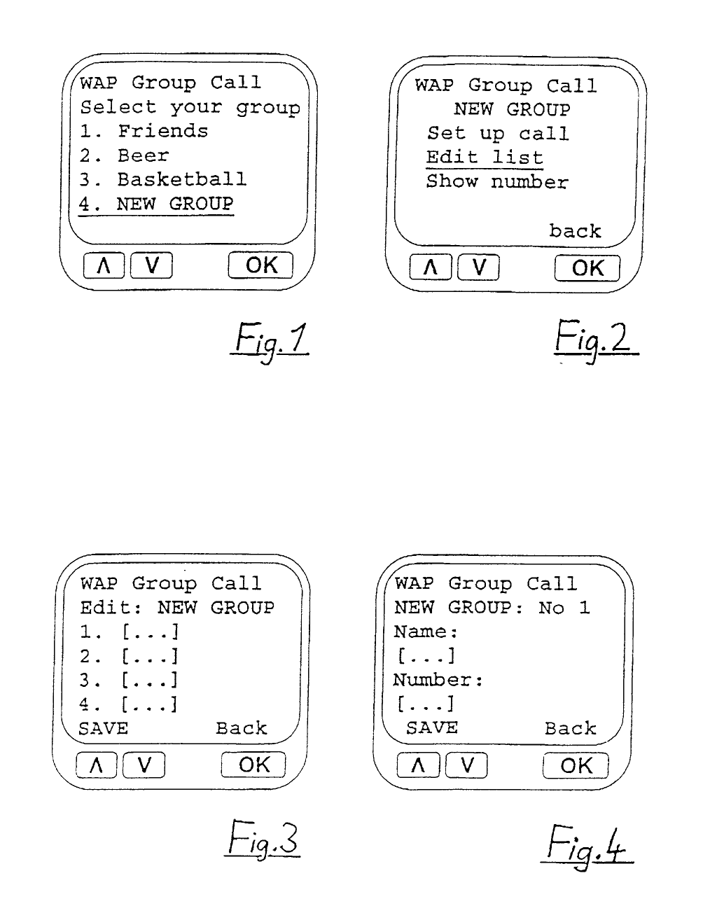

Apart from setting up the connection to the new group (after having defined it) under “set up call”, the new group can be entered (edit list) and the number of the list can be displayed (show number) when specifying the menu item edit list in FIG. 2, the menu according to FIG. 3 is displayed and after, for example, number 1 has been selected (with key 1 on the mobile terminal), the menu according to FIG. 4 is displayed. According to FIG. 4, name and phone number for participant 1 in the new group can be entered, for example, via the keys of the mobile terminal and stored in the menu after the item “save” has been selected. According to FIG. 4, the name of the list can be selected after at least one participant has been entered (suitably at least two participants) in the list (previous: preset=“new group”) and stored (save) according to FIG. 5.

A list is suitably defined only by entering at least two participants in the list.

The setting-up of a telephone conference to the participants listed in a list of participants for a telephone conference (or their telephone numbers etc.) can be technically implemented, in particular, in that in (at least) one mobile radio network, for example, 10 (or another number of) MSIDN numbers are predetermined, which, when they are dialed by a mobile terminal, initiate the setting up of a telephone conference circuit to the members of a list which, for the calling participant, is associated with this number for him. In this arrangement, all, e.g. 10, MSISDN numbers can also be in each case identical for all mobile radio subscribers of one or more mobile radio networks, for example +49172333301-+491723333310 being the same for all participants. When a list is dialed (for example in a menu in the terminal), the telephone number associated with this list is called up, whereupon the mobile radio network automatically initiates, on the basis of the dialing of this telephone number, the setting-up of a telephone conference to members of the list predetermined for this telephone number for the calling mobile radio subscriber. The list can be stored in the mobile radio network, in the mobile terminal or in a SIM card. If the telephone numbers of a list are stored at the mobile terminal end (e.g. in a card or a terminal), the numbers of a list which are to be called are transmitted to the mobile radio network in order to enable a connection to the participants to be set up there.

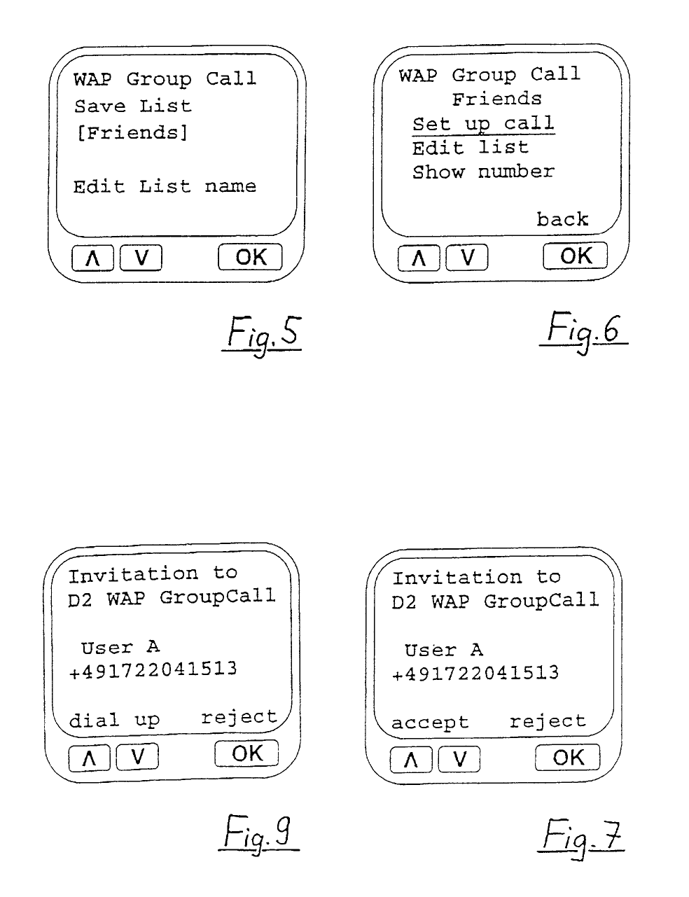

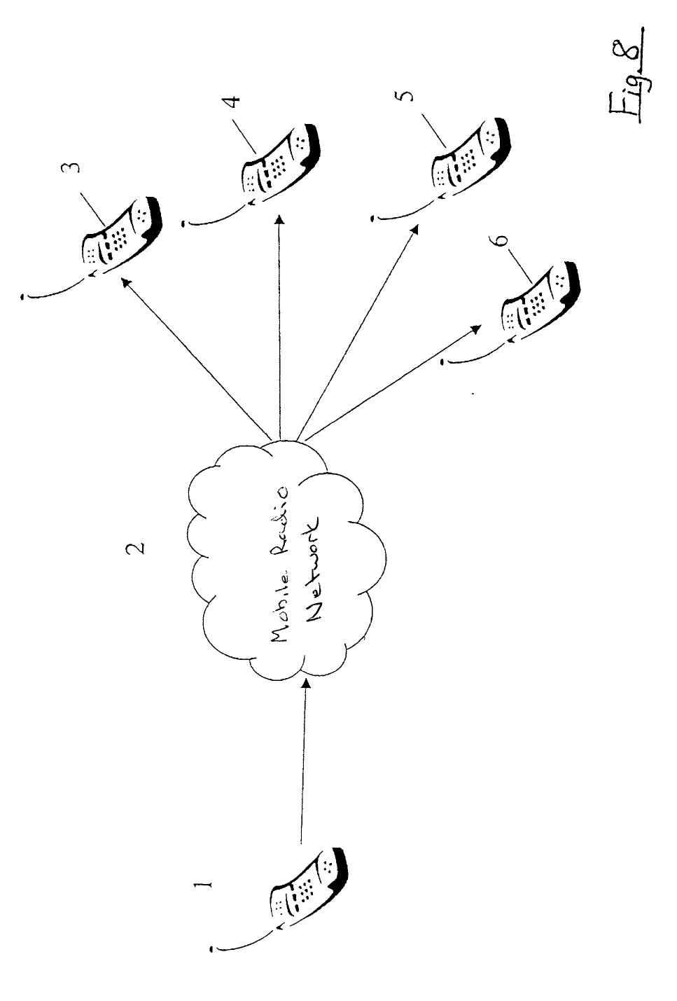

In principle, the connection set-up can be implemented, in particular, according to the two following exemplary embodiments. In an exemplary embodiment according to FIGS. 6-8, the connection set-up to the participants in a list is initialized at the network end (after a mobile radio subscriber applies for the telephone conference by calling an above-mentioned virtual telephone number etc.).

If a telephone conference for the “friends” group has been dialed by a mobile radio user according to the menu in FIG. 6 (set up call), the mobile terminal transmits (e.g. per SAT/WAP) the MSISDN associated with the group from the above-mentioned pool of, for example, 10 MSISDNs to the mobile radio network which sets up the connection to the other participants or allows it to be set up. The other participants in the telephone conference (which can be taken from the list for this group) receive an e.g. acoustic and/or alphanumeric invitation to participant in a telephone conference, displayed on their mobile terminal. This invitation can be transmitted, in particular, by WAP (WML content, e.g. WAP deck or WAP card) to the mobile terminals of the invited mobile radio subscribers 3, 4, 5. Such an invitation can be transmitted, for example, according to FIG. 7. In the example of FIG. 7, the acceptance or rejection of the invitation to the telephone conference is selected by means of the cursor keys and confirmed by selecting “ok”.

The telephone conference can be implemented in different ways. For example, it is possible for all participants in the telephone conference to talk and hear at the same time or, alternatively, for priorities to be issued.

The connection set-up to the participants of the list, which is initialized by the network, is shown by way of example in FIG. 8. On the left in FIG. 8, the mobile terminal 1 which requests the setting-up of the telephone conference is shown. For this purpose, it transmits, for example, a virtual telephone number (by mobile radio) to the mobile radio network 2. The mobile radio network 2 sends invitations (according to FIG. 7) (by mobile radio) to the participants 3, 4, 5, 6 of the group of mobile radio subscribers which are stored in the list for which list participant 1 has requested a telephone conference. If subscribers 3-6 of the list accept the invitation (or without invitation and automatically), they are connected to the telephone conference circuit by the mobile radio network 2.

As an alternative, a participant-initiated connection set up by in each case one invited participant 3-6 of the list is possible. In this case, an invitation according to FIG. 9 is sent and the invited person can in each case participate in the telephone conference by him, or by his mobile terminal, respectively, dialing a telephone number (virtual telephone conference number/bridge) transmitted with the invitation according to FIG. 9 whereupon he will be connected to the telephone conference. The invitation according to FIG. 9 can be transmitted, for example, as WML content to a WAP terminal.

The invited participants can be checked via various telecommunication identities, especially telephone numbers, e-mail addresses etc.

FIG. 10 diagrammatically shows the sequence for initiating the setting-up of individual connections by the individual terminals of the participants in the list. Mobile terminal 1 requests the telephone conference per mobile radio by means of a telephone conference initialization 16 (by mobile radio). A server 7 at the mobile radio network (2) end then sends invitations 8, 9, 10 to the mobile terminals of the participants 3, 4, 5 of the list for the requested telephone conference. The mobile radio subscriber stations 3, 4, 5 set up a connection (11, 12, 13, 14) to the telephone conference, if their user wishes to participate in the telephone conference (by pressing a key etc.), due to the fact that they dial a (virtual) telephone number transmitted with the invitation (according to FIG. 9) and are connected to a telephone conference. This is done via a bridge 8 via which the participants 1, 3, 4, 5 participating in the telephone conference are connected.

Thus, while there have been shown and described and pointed out fundamental novel features of the present invention as applied to a preferred embodiment thereof, it will be understood that various omissions and substitutions and changes in the form and details of the devices illustrated, and in their operation, may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

We claim:

1. A method for setting up a telephone conference between more than two subscribers of at least one telecommunication network on request by a subscriber, comprising the steps of:
storing a list of a predetermined group of subscribers; and
contacting, when a telephone conference is requested for the predetermined group of subscribers stored in the list, the subscribers taken from the stored list of subscribers for one of setting up and preparing for setting-up a telephone conference between the subscribers.

2. A method as defined in claim 1, wherein the telephone conference is a mobile radio telephone conference in which the least one subscriber participates via a mobile radio network.

3. A method as defined in claim 1, including requesting the telephone conference via a mobile radio telephone network.

4. A method as defined in claim 1, wherein a telephone connection of at least one subscriber is set up to a telephone conference by the subscriber calling a telephone number not associated with any other subscriber, whereupon, when the number is called, the telecommunication network connects subscribers to the telephone conference.

5. A method as defined in claim 4, including providing a limited number of mobile radio telephone numbers (IMSI) in at least one mobile radio telecommunication network, whereupon when the numbers are called by any mobile radio subscriber, a telephone conference is set up to this mobile radio subscriber.

6. A method as defined in claim 1, including, after a telephone conference has been requested by a subscriber, sending a message via a device at the mobile radio network end to the subscribers who are contained in the list for which list a telephone conference has been requested, and taking one of telephone numbers and other telecommunication identities of the subscribers from a list stored in one of the mobile radio network and by the subscriber requesting the telephone conference.

7. A method as defined in claim 1, including, for prepairing setting up of a telephone conference, sending an invitation to the telephone conference to subscribers who are stored in the list, whereupon an invited subscriber is only connected to the telephone conference if he accepts the invitation.

8. A method as defined in claim 7, including transmitting the request one of as short message and as WML content to the terminal.

9. A method as defined in claim 1, including controlling a telephone conference with an element at the mobile radio network end during the telephone conference with regard to at least one of termination of the conference, exclusion of a subscriber from the conference and addition of a further subscriber, not contained in the list, to the conference.

10. A method as defined in claim 1, wherein the storing step includes storing, for the group, in each case a list of at least one of names, telephone numbers and other telecommunication addresses of only each subscriber in the group but no other subscriber in at least one of the mobile terminal, a mobile radio subscriber identification card and the telecommunication network.

11. A method as defined in claim 1, including admitting only subscribers who are stored in a list for a group to a telephone conference for this group.

12. A method as defined in claim 1, including defining a list with regard to subscribers contained therein by at least one of mobile radio Internet (WAP) and landline network Internet.

13. A device for setting up a telephone conference between more than two subscribers, comprising: a control device operative so that, when a telephone conference is requested for a predetermined group of subscribers by a subscriber of a telecommunication network, the control device contacts subscribers of the predetermined group of subscribers, which subscribers are stored in a list for this group, for one of setting up and preparing the setting-up of a telephone conference between the subscribers.

14. A device as defined in claim 13, wherein the device is a server one of in a telecommunication network and having access to a telecommunications network.

15. A device as defined in claim 13, wherein the device includes an interface for receiving a request of a subscriber for setting up a telephone conference, a control device for setting up the telephone conference and an interface for connecting subscribers to one another as a telephone conference.

16. A device as defined in claim 15, wherein after the setting-up of the telephone conference has been prepared, a voice telephone conference is established.

17. A device as defined in claim 16, wherein the telephone conference is a mobile radio telephone conference in which at least one subscriber participates via a mobile radio network.

18. A device as defined in claim 14, wherein the subscriber requesting the telephone conference requests the telephone conference via a mobile radio telephone network.

19. A device as defined in claim 14, wherein the control device is operative so that a telephone connection from at least one subscriber to the telephone conference is set up when this subscriber calls a telephone number which is associated with no other subscriber, whereupon, when the number is called, the telecommunication network connects the subscriber to the telephone conference.

20. A device as defined in claim 14, wherein in at least one mobile radio telecommunication network, a limited number of mobile radio telephone numbers is provided, whereby when the numbers are called by any mobile radio subscriber, a telephone conference is set up for the mobile radio subscriber.

21. A device as defined in claim 14, wherein the device is at the mobile radio network and is operative to send, after a telephone conference has been requested by a subscriber, a message to the subscribers who are contained in the list for which the subscriber requests a telephone conference, the telephone numbers of the subscribers being taken from the list stored in the mobile radio network or by the subscriber requesting the telephone conference.

22. A device as defined in claim 14, wherein an invitation to the telephone conference is sent to a subscriber from a list for which a telephone conference is requested, the invited subscriber being connected to the telephone conference only if he accepts the invitation.

23. A device as defined in claim 22, wherein the device is operative so that the request is transmitted to the terminal one of as short message and as WML content.

24. A device as defined in claim 14, wherein the control device is operative to control a telephone conference during the telephone conference with regard to at least one of termination of the conference, exclusion of a subscriber from the conference and addition of a further subscriber, not contained in the list, to the conference, the control device being at the mobile radio network end.

25. A device as defined in claim 24, wherein for the group, in each case a list of at least one of names, telephone numbers and other telecommunication addresses of each subscriber of the group but no other subscribers is stored at least one of in the mobile terminal, in a mobile radio subscriber identification card and in a memory in the telecommunication network.

26. A device as defined in claim 4, wherein only subscribers who are stored in a list for a group are admitted to a telephone conference for this group.

27. A device as defined in claim 14, wherein the list is defined with regard to subscribers contained therein by at least one of mobile radio Internet and landline network Internet.
